(19) United States
(12) Patent Application Publication
(10) Pub. No.: US 2004/0016226 A1
(43) Pub. Date: Jan. 29, 2004

(54) RADIAL IMPULSE TURBINE FOR ROTARY RAMJET ENGINE

(75) Inventors: Shawn P. Lawlor, Redmond, WA (US); Donald Kendrick, Sammamish, WA (US)

Correspondence Address: R REAMS GOODLOE, JR. & R. REAMS GOODLOE, P.S., 24722 104TH. AVENUE S.E., SUITE 102, KENT, WA, 98030-5322, US

(73) Assignee: RAMGEN POWER SYSTEMS, INC.

(21) Appl. No.: 10/200,854

(22) Filed: Jul. 23, 2002

Related U.S. Application Data
(60) Provisional application No. 60/386,194, filed on Jul. 23, 2001.

(51) Int. Cl. F02C 3/16

(52) U.S. Cl. 60/39.35

(57) ABSTRACT

A rotary ramjet engine generator set with exhaust turbine. A rotary ramjet engine is provided operating with a very low axial flow component. The engine has a closely housed rotor and shaft mounted for rotary motion with respect to an engine case. An exhaust turbine is affixed on a common shaft, or on coaxial shaft portions operating in unison, with a rotary ramjet engine. By properly matching the exhaust turbine rotating speed with the ramjet rotor rotating speed, the residual energy of the exhaust gas from the ramjet engine is efficiently captured by the exhaust turbine. The exhaust turbine includes a curved, substantially conical hub having an exterior surface from which turbine blades extend, and a pressure accumulating housing which connects the outlet of the ramjet with the inlet to the exhaust turbine. Just upstream of the exhaust turbine, an outlet nozzle block is provided to expand the exhaust gases and send a jet of gases substantially tangential to the exhaust turbine. Exhaust gas first moves substantially inwardly along the impeller blades and then is exhausted to an outlet duct.

### RELATED PATENT APPLICATIONS

This invention is related to my U.S. Provisional Patent Application Express Mail No. EU230416492US (petition to convert to provisional patent application filed Jul. 17, 2002), converted from prior U.S. patent application Ser. No. 09/912,239, filed on Jul. 23, 2001, entitled Radial Impulse Turbine for Rotary Ramjet Engine, the disclosure of which is incorporated herein in its entirety by this reference.

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention is related to rotary ramjet engines and their components and particularly to the use of turbines for extraction of additional energy from exhaust gases leaving such engines. Such rotary ramjet engines are particularly useful for generation of electrical and mechanical power at efficiencies substantially improved over power plants currently in widespread commercial use.

### BACKGROUND

A continuing demand exists for a simple, highly efficient and inexpensive power plant that can reliably provide electrical and mechanical power. A variety of small to medium size electrical and/or mechanical power plant applications could substantially benefit from a prime mover that provides a significant improvement from the currently known net efficiencies. Specifically, improved efficiency is increasingly important as fuel costs continue to rise. Such small to medium size mechanical or electrical power plants—typically but not exclusively from about 1 megawatt up to as much as about 100 megawatts—are required in a wide range of industrial applications, including stationary electric power generating units, in rail locomotives, and in marine power systems. Power plants in this general size range are well suited to use in industrial and utility electrical generation and cogeneration facilities. Such equipment is often employed to provide prime movers for electrical power needs while simultaneously supplying thermal energy to an industrial facility. Increasingly, such equipment is used to provide stand-alone merchant electric power production facilities.

Power plant designs which are now commonly utilized in such applications include (a) gas turbines, driven by the combustion of natural gas, fuel oil, or other fuels, and which capture the kinetic energy from the exiting combustion gases, (b) steam turbines, driven by the expansion of steam that is generated by heat recovery steam generators at gas turbine facilities, or by the expansion of steam generated in stand alone facilities from boilers via the combustion of coal, fuel oil, natural gas, solid waste, or other fuels, and (c), from large scale reciprocating engines, usually diesel cycle and typically fired with fuel oils.

Of the currently available power plant technologies, diesel fueled reciprocating engines and advanced gas turbine engines have the highest efficiency levels. Gas turbines perform more reliably than reciprocating engines, and are therefore frequently employed in plants that have higher power output levels. However, because gas turbines are only moderately efficient in converting fuel to electrical energy, gas turbine powered plants are most effectively employed in co-generation systems where both electrical and thermal energy can be utilized. In that way, the moderate efficiency of a gas turbine can, in part, be counterbalanced by increasing the overall cycle efficiency with the use of exhaust heat extraction techniques.

Because of their modest efficiency in conversion of fuel input to electrical output, the most widely used types of power plants, namely gas turbines and combustion powered steam turbine systems, often depend upon cogeneration in industrial settings in order to achieve acceptable costs of production of electricity. Therefore, it can be appreciated that it would be desirable to reduce costs of electrical production by generating electrical power at higher overall efficiency rates than is commonly achieved today.

### SUMMARY

Disclosed herein are various embodiments and aspects of technology for the application of a turbine reacting to an exhaust gas stream from a rotary ramjet power plant. A power plant design, involving the use of a ramjet engine as the prime mover, has higher overall cycle efficiencies when compared to those heretofore-used power plants of which we are aware. Compared to many power plants commonly in use today, such a power plant design is simple, more compact, relatively inexpensive, easier to install and to service, and/or otherwise superior to currently operating plants of which we are aware.

To even further enhance the efficiency of such power plants, a unique radial turbine design has been developed in which the turbine is affixed on a common shaft (or on complementary shaft portions acting along a common rotating axis) with a rotary ramjet engine, and turns as the same rotary speed as the ramjet engine rotor. By properly designing the radial turbine blade shape in view of the ramjet rotor rotating speed, and the ramjet combustor operational characteristics, the energy of the exhaust gas from the ramjet engine is efficiently captured by the radial turbine. More specifically, in a preferred embodiment, the radial turbine eliminates the need to capture turbine power output via a separate, external gear and/or a separate electrical generation device. The common shaft mounted radial turbine is beneficial commercially because it enables a power plant to avoid additional separate power output or generation equipment, yet captures otherwise discarded energy from the exhaust gases, thus increasing overall efficiency.

In one embodiment of the radial turbine planetary gear configuration, an impulse turbine includes an impeller which is affixed to an extended output shaft portion of the ramjet rotor shaft. Energetic exhaust gases leaving the ramjet combustion chamber are exhausted outward into a slightly pressurized turbine inlet duct. The exhaust gases exit the turbine inlet duct through an outlet nozzle block, which creates a jet of exhaust substantially tangentially to the turbine impeller. The gases act on the impeller blades, and flow radially inward toward the hub of the impeller, then move rearwardly and expand slightly through a downstream outlet through a plurality of turbine impeller blade exit nozzle portions By selection of turbine speed, based on the rotary ramjet engine operating parameters, a turbine blade configuration may be preselected, so that the turbine has its rotational energy, as captured from the exhaust gases, transferred to the output shaft at the output shaft rate of rotation. A combustion exhaust gas duct may be used to collect and discharge the hot exhaust gas stream to a conduit for transport to a heat exchanger, where the hot exhaust gases are cooled by way of heating up a heat transfer fluid, such as water, in which case the production of hot water or steam results. The heat transfer fluid may be utilized for thermal purposes, or for mechanical purposes, such as driving a steam turbine. In any event, ultimately, the cooled combustion gases are exhausted to the ambient air.

From the foregoing, it will be apparent to the reader that one aspect of the present invention resides in the provision of a rotary ramjet engine to generate mechanical and/or electrical power.

More specifically, one of the many objectives achievable by the developments taught herein may be advanced by providing a ramjet driven power generation plant that is capable of reliably and efficiently recovering kinetic energy from exiting combustion gases.

Other objectives of the various embodiments and aspects of the invention reside in the provision of rotary ramjet engine driven power generation plants which:

have efficient exhaust turbines for energy recovery from the ramjet exhaust system;

has an exhaust turbine blade design that allows efficient energy recovery even when the ramjet engine rotates at very high tip speeds;

which enable the direct power transfer from the exhaust turbine to the output shaft;

have high efficiency rates; that is, provides a high work output relative to the heating value of fuel input to the power plant;

allow the generation of power to be done in a simple, direct manner;

require less physical space than existing technology power plants;

are easy to construct, to start, and to service;

Other aspects and advantages of the various embodiments and aspects of the invention will become apparent to those skilled in the art from the foregoing and from the detailed description that follows and the appended claims, in conjunction with the accompanying drawing.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

FIG. 1 provides a partial cross-sectional view of the rotating assembly of an exemplary power plant apparatus, showing rotating output shaft affixed to a rotor and rotatably secured therewith, and with a radial turbine mounted for rotary motion in response to exiting combustion gas, and showing the turbine affixed to a common shaft with the high speed rotor, and the exhaust heat recuperation equipment for cogeneration applications, as well as an electrical generator, gearbox, and shaft coupling.

FIG. 2 is a side elevation view of a fully assembled power plant apparatus of the type first illustrated in FIG. 1 above, showing, from right to left, a starter motor, an electrical generator, a gear box, a shaft coupling, the output shaft, an inlet air plenum, the basic rotary ramjet engine, and the impulse turbine casing.

FIG. 3 is a partially sectioned perspective view of a portion of the impulse turbine, illustrating the flow path for the hot exhaust gases from the exit of the ramjet into an exhaust gas plenum, and then to the radial impulse turbine.

FIG. 4 is a partially sectioned perspective view of the impulse turbine assembly, seen as if assembled external to the rotary ramjet engine, wherein the impulse turbine is illustrated as if mounted on an unseen output shaft, and showing the hub, and illustrating substantially radial impeller blades with a final expansion/deflection nozzle portion on the distal end portion thereof.

FIG. 5 is a perspective view of a radial turbine impeller, showing the substantially radial turbine blades extending above a curved substantially conical impeller base.

FIG. 6 is a simplified flow diagram depicting capture of thermal energy from an exhaust gas stream to produce steam or hot water, after capture of kinetic energy in an impulse turbine.

FIG. 7 is a perspective view of a nozzle blade for use in a block of nozzles surrounding the periphery of the inlet to the radial turbine, showing how each nozzle blade is affixed utilizing a bolt, as well as graphically illustrating the redirection of exhaust gases by the nozzle blade by an angle alpha.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, variations in the elements of the ramjet engine with radial exhaust gas turbine, especially as applied for different variations of the functional components illustrated, may be utilized in various embodiments in order to provide a robust ramjet engine suitable for a variety of engine designs and applications.

### DETAILED DESCRIPTION

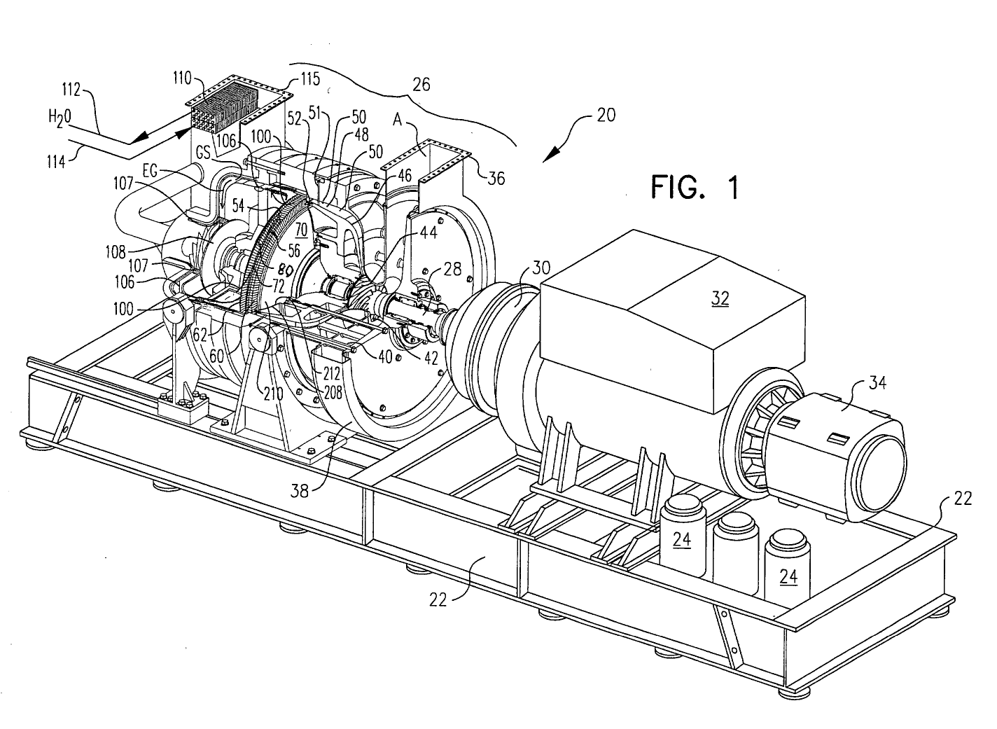

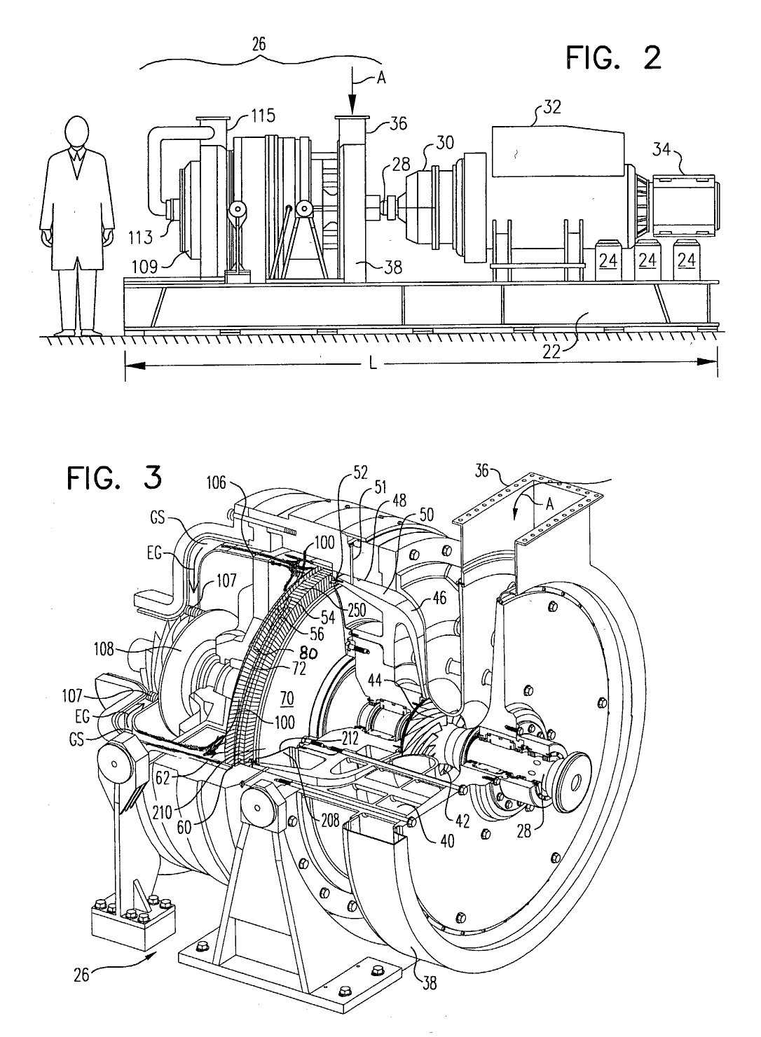

A perspective overview of an exemplary compact electrical generator set 20 is provided in FIG. 1. Components shown include the rail frame skid 22 with integral lubrication oil reservoir and adjacent lube oil pumps 24, the compact rotary ramjet engine 26 with output shaft 28, a gearbox 30, an electrical generator 32, and a starter motor 34. Inlet air as indicated by reference letter A is supplied via inlet duct 36 to a circumferential inlet air supply plenum 38 and thence through a substantially radial air inlet 40 for supply to a pre-swirl compressor inlet 42. From compressor inlet 42 a pre-swirl compressor 44 provides compression of the inlet air A. In one desirable configuration, about 1.0 psig of pressure, more or less, is developed. As better seen in FIG. 3, the compressed inlet air is allowed to decelerate in a diffuser portion 46 of pre-swirl compressor outlet duct 48, to build a reservoir of low velocity pressurized inlet air. Subsequently, converging portion 50 of outlet duct 48 convects inlet air to the primary fuel injectors 51. Then, the resultant fuel air mixture is deflected by inlet guide vanes 52 (of which only one guide vane 52 in the guide-vane row is shown in FIGS. 1 and 3) to provide both axial and tangential ramjet inlet velocities as required to produce, at design conditions, a negligible inflow angle of attack at the leading edge 54 of the ramjet inlet centerbody 56.

The supersonic ramjet inlet utilizes the kinetic energy inherent in the air mass or fuel/air premix due to the relative velocity between the ramjet inlet and the supplied air or fuel/air premix stream, to compress the inlet air (or, alternately, the inlet fuel/air mixture), preferably via an oblique shock wave structure. As illustrated herein, in order to carry out reliable, thorough combustion in the combustion chamber 72, the inlet stream is compressed utilizing a shock wave flow pattern operating with compression primarily laterally with respect to the plane of rotation of the rotor 70, to compress the inlet fuel/air mix between the inlet centerbody 56 and adjacent inlet 60 and outlet 62 strake structures. In the rotary ramjet engine 26 shown herein, compression and combustion is preferably achieved utilizing a small number of ramjets, (normally expected to be in the range from 2 to 5 total, with accompanying inlet and outlet strakes), and within an aerodynamic duct formed by the spirally disposed, or more specifically, helically disposed inlet 60 and outlet 62 strakes, as opposed to a traditional gas turbine or other axial flow compressor which utilizes many rotor and stator blades.

In order to obtain the proper conditions for combustion while minimizing undesirable products of combustion, the fuel and combustion air are preferably premixed prior to feed to the ramjet inlet. As illustrated in FIG. 3, fuel injectors 51 add necessary amounts of fuel to an inlet fluid entering through diffuser 48. The inlet fluid may be either a fuel free oxidant containing stream, or may contain some high value fuel such as hydrogen, or some low value fuel, such as coal bed methane, coal mine purge gas, landfill methane, biomass produced fuel gas, sub-quality natural gas, or other low grade fuels. In order to carry out the actual combustion step in an operationally reliable manner, the velocity of the compressed inlet fuel/air mixture must be high at the intermixing point between the combustion chamber and the delivery point of the combustible fuel/air mixture, so that flashback of the flame front from the combustor toward the inlet is avoided. In the rotary ramjet engine 26 described herein, the residence time in the diffuser is too short, and the total pressure too low, to initiate an auto-ignition process. Further, by the time the premix is compressed and heated, the in-flowing fluid has substantially entered the combustion chamber, and thus ignition or detonation is substantially avoided in this engine design, unlike, for example the situation in a conventional gas turbine compressor when ingesting an air stream having fuel therein.

In order to stabilize the combustion process downstream of the rear wall 80 of inlet centerbody 56, the velocity through the combustion chamber 72 is substantially reduced by providing a combustion chamber 72 having larger flow area than provided by the inlet ducts thereto, i.e., the passageways between the inlet centerbody 56 and the inlet 60 and outlet 62 strakes. High-speed exhaust gas exiting the combustion chamber 72 propels the rotor 70 at the desired rim speed under design load conditions. Accordingly, in the ramjet configuration illustrated, the acceleration and deceleration of the inlet fluid, and the acceleration and deceleration of the outlet combustion gases, is accomplished efficiently.

As illustrated in FIGS. 1 and 3, the hot gas products of combustion, as indicated by reference arrow 100, after discharge from the combustion chamber 72 flow through a ramjet outlet nozzle, and thence along the outlet strake 62, and are directed rearward to turbine inlet duct 106. In turbine inlet duct 106, pressure is established, up to as much as 40 psig or so. Prior to feed to the turbine 108, the hot exhaust gases exiting the ramjet combustor are accumulated in a pressure accumulator 121 to capture energy therein. The pressure accumulator 121 has an inlet 123 and an exit 125. At the exit 125 of the pressure accumulator 121, a block of outlet nozzles 107 is provided.

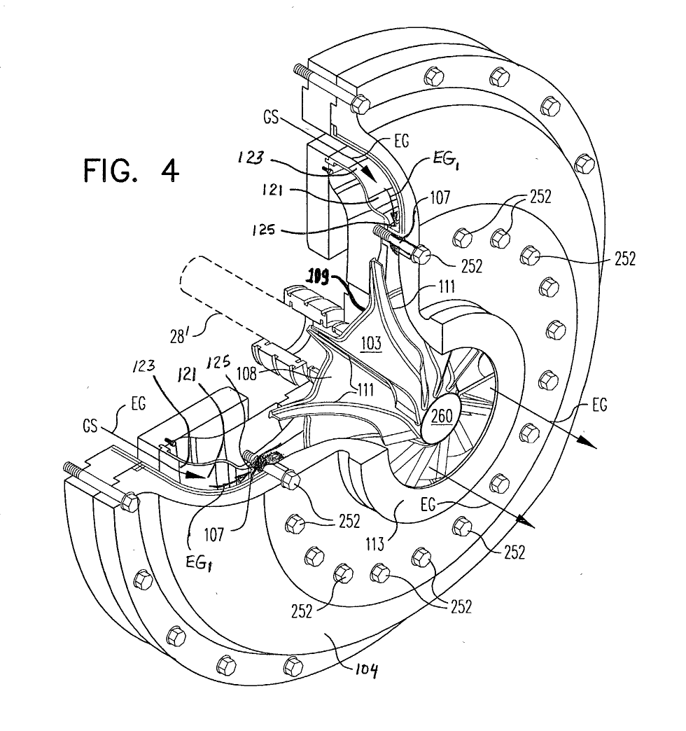

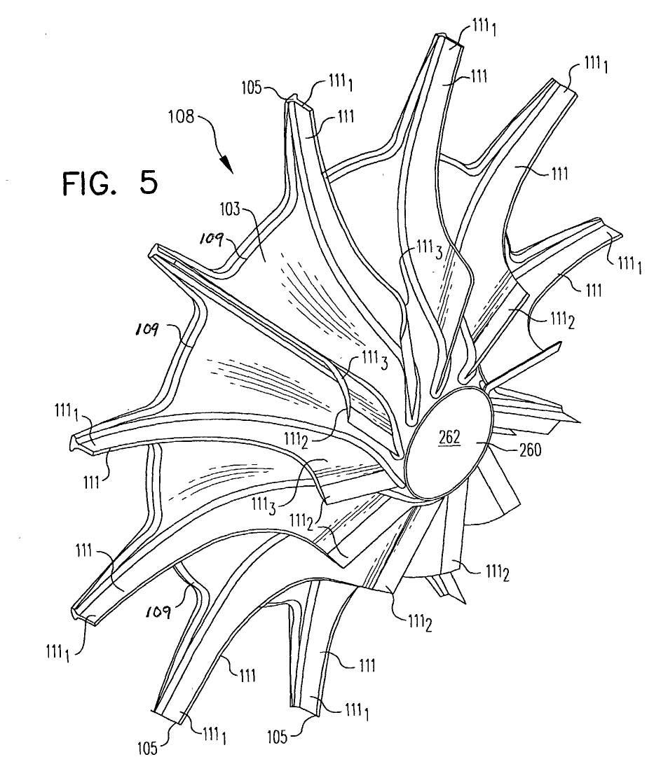

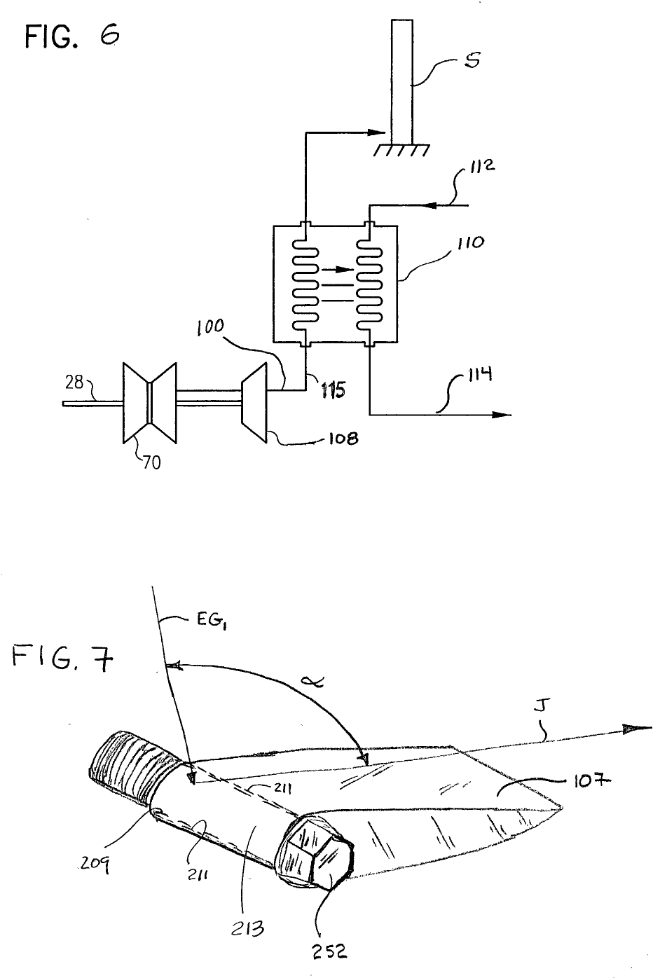

As seen in FIGS. 4 and 7, the exhaust gases GS in the turbine inlet duct 106 escape radially inward in the direction of reference arrow EG1 then is redirected by an angle alpha (α) to a direction that is substantially tangential to turbine impeller 108 via redirection between adjacent outlet nozzles 107 in a circular patterned block of outlet nozzles 107. As depicted the angle alpha (α) is at or slightly larger than about ninety degrees. In this way, exhaust gas pressure is converted to exhaust gas jets J acting substantially tangentially to the periphery of the inlet edge 109 of the turbine impeller 108. Note, as better illustrated in FIG. 5, that the impeller blades 111 have proximal ends 105 that form the start of inlet portions 1111 of the impeller blades 111. The proximal ends 105 extend outward in a starfish arm fashion from the inlet edge 109 at the base 103 of impeller 108. The energetic exhaust gas products thence race radially inwardly along impeller blades 111 and thence escape rearwardly, with additional expansion and deflection against exit portion 111₂ of blades 111, and thence outward from the outlet 113 of casing 104 of the turbine impeller 108. During the flow across the turbine impeller blades 111, energy is extracted and work is applied to the exit or hot section output shaft portion 28′. In various embodiments, exit output shaft portion 28′ may be a single common shaft, or cooperative shaft portions acting along a common rotational centerline axis, depending upon the design of the output shaft 28 (and possibly 28′) in conjunction with rotor 70. In this manner, the rotor 70 and the turbine impeller 108 can rotate in a common direction.

For enhanced efficiency, the hot exhaust gases 100 may be further utilized by capturing thermal energy therein by being directed, after outlet 113, to an exhaust heat exchanger 110 in duct 115, to heat condensate 112 and produce hot water or high pressure steam 114, before discharge via stack S. The high pressure steam 114 may be utilized in any applicable process host as is typical in a cogeneration system, or utilized in high pressure steam turbine blades yet additional to the ramjet engine design disclosed herein.

The exemplary embodiment of the ramjet engine generator set 20 as just described, operating at the exemplary conditions as described, typically has a net system efficiency in excess of 30%, and at rated power is of at least 32%, and more preferably, of at least 35%, when operating using an impulse turbine for recovery of kinetic energy from hot exhaust gases, but without a steam turbine. When a steam turbine is employed, the net system efficiency at rated power output is preferably at least 38%. More preferably, the net system efficiency at rated power output of such a system configuration is at least 45%, where the quality of generated steam permits.

It should also be noted that in order to minimize aerodynamic drag and efficiently operate the outer portions of the rotor 70 at supersonic tangential velocities, means should be provided to reduce drag of the rotor 70. This can take the form of a fixed housing 208 with a small interior gap G between the rotor surface 210 and an interior 212 of housing 208. Such rotor drag minimizing techniques are taught in U.S. Pat. No. 5,372,005, issued Dec. 14, 1994 to Lawlor, which patent is incorporated herein in its entirety by this reference. Alternately, vacuum means can be utilized to remove air from adjacent the rotor 70, in order to minimize drag.

With respect to the exhaust gas blades 111 of the impulse turbine impeller 108, the exhaust flow typically has a high degree of recoverable energy. The radially inward exhaust gas flow, noted as exhaust gas EG₁ in FIGS. 4 and 7, provides a high velocity gas, which is changed in direction by deflection through adjacent outlet nozzles 107 of the type noted in FIG. 7. Any suitable shape may be chosen for nozzles 107, as necessary for maximizing efficiency at the selected gas properties and velocities, but as shown in FIG. 7, an airfoil shape nozzle 107 is suitable in some embodiments. In such a design, an aperture 209 defined by interior edge walls 211 in a leading edge lobe portion 213 provides space for fitting therethrough of bolt 252, for the nozzle 107 to be secured in a block pattern in the casing 104.

As discussed above, the radially inward flow path of the exhaust gas EG₁ is changed in direction by an angle alpha (α) via redirection between adjacent nozzles 107 in the nozzle block arranged in a circular pattern as denoted by bolts 252 (see FIG. 4). The kinetic energy in exhaust gas jets (identified by reference numeral J in FIG. 7) is thus captured in the impulse turbine. This is because most or substantially all of the remaining pressure in the exhaust gas flow is expanded, and leaves the outlet nozzle block 107 at near atmospheric pressure. Thus, a preferred turbine stage for extracting the remaining energy is designed to capture and convert the jet velocity into useable mechanical power, and preferably avoids additional complexity of appreciable pressure decrease or expansion of the exhaust gas flow stream. In other words, it is preferable to utilize a substantially constant-pressure or impulse type turbine for this application. However, it is to be understood that it is not required that the turbine be a pure impulse turbine, and indeed, utilization of at least some energy in the exhaust stream via residual pressure-expansion is permissible, and is within the teaching provided herein, as will be understood by those of ordinary skill in the art and to whom this disclosure is addressed.

The impulse turbine 108 is important because of the additional energy recovery and overall system efficiency improvement provided. As an example, for a ramjet rotor wherein the rim 250 of rotor 70 has a Mach number of 2.75, the ramjet flowpath would develop approximately 303 horsepower (gross, before system losses) of mechanical shaft power per pound mass flow of exiting the ramjet. Then, in the impulse turbine, assuming an efficiency of 80 percent, the impulse turbine could extract as much as 100 horsepower or more, and even up to as much as 118 horsepower, per pound mass from the ramjet exhaust flow. Of course, these numbers may vary for any specific design. For example, In various embodiments, the design taught herein may be applicable for operation of rotor 70 rim 250 at a Mach number of at least 1.5, and more generally, in the range from 1.5 to about 3.0. In some embodiments, an optimum range for Mach number of the rotor 70 of the rim 250 would range at 2.5 or more.

Attention is now directed to FIGS. 4 and 5. In FIG. 4, note that a plurality of outlet nozzles 107 are located circumferentially about the inlet to the impulse turbine 108, with their location being foreshadowed by way of the location of fasteners 252. Also, note that impeller 108 is mounted at its hub 260 (having interior sidewall 262) on shaft portion 28′, indicated only in hidden lines. Also, the surface 103 of the impeller hub 108 slopes inwardly and rearwardly, preferably in a smoothly curved, somewhat conical shape. And, although impeller 111 has been described as having an inlet portion 111₁ and outlet portion 111₂, the impeller 111 may also have a distinct transition zone 111₃ therebetween, with the exact shape being selected for a particularly service, velocity, and pressure profile.

Although only a few exemplary embodiments and aspects of this invention have been described in detail, various details are sufficiently set forth in the drawing and in the specification provided herein to enable one of ordinary skill in the art to make and use such exemplary embodiments and aspects which need not be further described by additional writing in this detailed description. Importantly, the designs described and claimed herein may be modified from those embodiments provided without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations of the present invention are possible in light of the above teachings. It is therefore to be understood that within the scope of the appended claims, the invention may be practiced otherwise than as specifically described herein. Thus, the scope of the invention, as set forth in the appended claims, and as indicated by the drawing and by the foregoing description, is intended to include variations from the embodiments provided which are nevertheless described by the broad interpretation and range properly afforded to the plain meaning of the claims set forth below.

1. A ramjet engine comprising, in combination:
(a) rotating components, in series flow:
(1) a rotary ramjet, said rotary ramjet comprising (A) a rotor turning at a first rotating speed, and (B) at least one rotary combustion chamber portion comprising (i) a ramjet compression inlet (ii) a flame holder, (iii) an outlet nozzle on a rotor; and (iv) an output shaft;
(2) an exhaust impulse turbine, said impulse turbine affixed to said output shaft and turning at the same rotary speed as said shaft;
(b) adjacent static housing structure defining
(1) an engine casing (A) having an inner wall surface defining a static combustion chamber portion, (B) said rotary and said static combustion chamber portions adapted to work together to receive fuel from a fuel supply and inlet air from said inlet air compressor to burn said fuel and produce a hot exhaust gas flow to impart rotary motion to said rotor; and
(2) an external turbine casing peripherally confining said impulse turbine, said impulse turbine adapted to receive said hot exhaust gas flow and turn said output shaft.

2. The apparatus as set forth in claim 1, wherein said output shaft comprises an inlet side portion and an outlet side portion, and wherein said turbine is affixed to said outlet side portion.

3. The apparatus as set forth in claim 1, wherein said first rotating speed is the speed of rotation of said exhaust turbine.

4. The apparatus as set forth in claim 1, wherein said rotor rotates in a first direction of rotation, and wherein said exhaust turbine rotates in a second direction of rotation, and wherein said first and said second directions of rotation are the same.

5. The apparatus as set forth in claim 1, wherein said exhaust turbine comprises, at least in part, an impulse turbine.

6. The apparatus as set forth in claim 1, wherein said hot exhaust gases exiting said ramjet combustor are accumulated in a pressure accumulator to capture energy therein, said pressure accumulator having an inlet and an exit.

7. The apparatus as set forth in claim 6, further comprising an outlet nozzle block, said outlet nozzle block located at said exit to said pressure accumulator.

8. The apparatus as set forth in claim 1, wherein said exhaust turbine comprises a set of impeller blades, and wherein said impeller blades are adapted to react against, and capture kinetic energy from said hot exhaust gases exiting said outlet nozzle.

9. The apparatus as set forth in claim 1, wherein said exhaust turbine comprises an impeller, said impeller having (i) an outwardly curved gas deflection surface, and (ii) a plurality of blades, said blades at least partially extending substantially radially inward along said outwardly curved gas deflection surface.

10. The apparatus as set forth in claim 7, wherein said apparatus outlet nozzle block comprises a plurality of fixed inlet guide vanes, said fixed inlet guide vanes located, flow-wise, upstream of said exhaust turbine impeller.

11. The apparatus as set forth in claim 1, wherein said apparatus further comprises, downstream of said impulse turbine, a heat recuperator adapted to transfer heat from exhaust gases leaving said exhaust turbine to an H₂O stream.

12. The apparatus as set forth in claim 1, further comprising a heat recovery steam generator, said heat recovery steam generator adapted to receive and cool said hot exhaust gas flow and to produce pressurized steam therefrom.

13. The apparatus as set forth in claim 1, further comprising a first electrical generator, said first electrical generator driven by said rotor shaft.

14. The apparatus of claim 1 wherein said rotary ramjet operates at a speed of at least Mach 1.5.

15. The apparatus of claim 1 wherein said rotary ramjet operates at a speed between Mach 1.5 and Mach 3.0.

16. The apparatus of claim 1 wherein each of said rotary ramjet operates at about Mach 2.5 or more.

17. The apparatus of claim 1, wherein said apparatus operates at about Mach 2.75.

18. The apparatus as set forth in claim 1, wherein net system efficiency at rated power is at least 30%.

19. The apparatus as set forth in claim 1, wherein net system efficiency at rated power is at least 35%.

20. A ramjet engine comprising, in combination:
(a) rotating components, in series flow:
(1) a rotary ramjet engine means, said rotary ramjet engine means comprising (A) a rotor turning at a first rotating speed, and (B) at least one rotary combustion chamber portion comprising (i) a ramjet compression inlet for compression of incoming air, (ii) a flame holder, (iii) an outlet nozzle on said rotor, and (iv) an output shaft;
(2) an exhaust turbine turning at said first rotating speed;
(b) adjacent static housing defining
(1) an engine casing (A) having an inner wall surface defining a static combustion chamber portion, (B) said rotary and said static combustion chamber portion adapted to work together to receive fuel from a fuel supply and inlet air from said ramjet compression inlet to burn said fuel and produce a hot exhaust gas flow to impart rotary motion to said rotor; and
(2) an external turbine casing peripherally confining said exhaust turbine, said exhaust turbine adapted to receive said hot exhaust gas flow and turn said output shaft.

21. The apparatus as set forth in claim 20, wherein said hot exhaust gases exiting said ramjet combustor have residual pressure captured by a turbine pressure accumulator, and an outlet nozzle block which allows said hot exhaust gases to expand and create a jet having a velocity component substantially tangential to said exhaust turbine, and wherein said impulse turbine comprises a set of impeller blades adapted to react against, and capture kinetic energy from, said hot exhaust gases.

22. The apparatus as set forth in claim 21, wherein said outlet nozzle block comprises a plurality of fixed inlet guide vanes, said fixed inlet guide vanes located, flow-wise, upstream of said impeller blades on said exhaust turbine.

23. The apparatus as set forth in claim 20, wherein said apparatus further comprises, downstream of said exhaust turbine, a heat recuperator, said last heat recuperator adapted to heat H₂O from said exhaust gas stream.

24. The apparatus as set forth in claim 20, further comprising a heat recovery steam generator, said heat recovery steam generator adapted to receive and cool said hot exhaust gas flow and to produce pressurized steam therefrom.

25. The apparatus as set forth in claim 20, further comprising a first electrical generator, said first electrical generator driven by said output shaft.

26. The apparatus of claim 20 wherein said rotary ramjet engine means operates at a speed of at least Mach 1.5.

27. The apparatus of claim 20 wherein said rotary ramjet engine means operates at a speed between Mach 1.5 and Mach 3.0.

28. The apparatus of claim 20 wherein each of said rotary ramjet engine means operates at about Mach 2.5 or more.

29. The apparatus as set forth in claim 20, wherein net system efficiency at rated power is at least 30%.

30. The apparatus as set forth in claim 20, wherein net system efficiency at rated power is at least 35%.
